(19) United States
(12) Patent Application Publication
(10) Pub. No.: US 2015/0369359 A1
(43) Pub. Date: Dec. 24, 2015

(54) CONTROL DEVICE AND CONTROL METHOD FOR TRANSMISSION

(71) Applicant: AISIN AW CO., LTD., Anjo-shi, Aichi (JP)

(72) Inventors: Hiroshi TSUTSUI, Nishio (JP); Satoru KASUYA, Nishio (JP); Masashi KITO, Anjo (JP); Takeshi TORII, Anjo (JP); Masayuki UCHIDA, Anjo (JP)

(73) Assignee: AISIN AW CO., LTD., Anjo-shi, Aichi-ken (JP)

(21) Appl. No.: 14/765,269

(22) PCT Filed: Feb. 26, 2014
(86) PCT No.: PCT/JP2014/054723

§ 371 Date: Jul. 31, 2015

(30) Foreign Application Priority Data
Feb. 26, 2013 (JP) 2013-036368

(51) Int. Cl. F16H 61/02; F16H 59/44; F16H 59/14; F16H 61/686; F16H 59/42

(52) U.S. Cl. CPC F16H 61/0213; F16H 61/686; F16H 59/42; F16H 59/14; F16H 59/44; F16H 2061/023; F16H 2059/147; F16H 2312/02

(57) ABSTRACT

A speed change engages a clutch and a brake such that an automatic transmission establishes a second speed as a starting speed when starting an automobile, and maintains the clutch in the engaged state when a speed change condition for changing the shift speed of the automatic transmission from the second speed to a first speed is met). With the second speed established, the speed change engages the brake so as to slip when the speed change condition for shifting from the second speed to the first speed is met.

The exemplary embodiments relate to a control device and a control method for a transmission that establishes a starting speed through engagement of first and second engagement elements and that establishes a lower speed having a speed ratio that is higher than that of the starting speed through engagement of the first engagement element and a one-way clutch.

### BACKGROUND

Hitherto, there has been known a control device for a transmission that performs squat control in which a higher speed having a speed ratio that is lower than that of a first speed is temporarily established through engagement of a first clutch C1 and a second clutch C2 when a shift range is switched from a non-travel range to a travel range and thereafter the first speed is established by disengaging the second clutch C2 and engaging a one-way clutch (see Patent Document 1, for example). In the control device for a transmission, in the case where a vehicle is started with the transmission establishing the higher speed in order to suppress idling of drive wheels, the higher speed is established through the squat control, and thereafter the squat control is ended without disengaging the second clutch C2. This allows the vehicle to start with the transmission establishing the higher speed.

### RELATED-ART DOCUMENTS

### Patent Documents

[Patent Document 1] Japanese Patent Application Publication No. 2008-286226 (JP 2008-286226 A)

### SUMMARY

In the case where a driver requests a large drive force after the vehicle is started with the transmission establishing the higher speed as discussed above, it is necessary to change the shift speed of the transmission from the higher speed (starting speed) to the first speed (lower speed). In this event, in order to favorably meet the drive force request from the driver, it is necessary to promptly execute shifting from the higher speed to the first speed. In changing the shift speed, however, it is generally determined on the basis of the vehicle speed and the accelerator operation amount whether or not to change the shift speed, and engagement and disengagement control for clutches and brakes is started in accordance with the result of the determination. Therefore, it is difficult to promptly change the shift speed from the higher speed to the first speed in response to the drive force request from the driver after the vehicle is started.

It is therefore a main object of exemplary embodiments to promptly change the shift speed of a transmission from a starting speed to a lower speed having a speed ratio that is higher than that of the starting speed in response to a drive force request from a driver after the vehicle is started, the transmission being configured to establish the starting speed through engagement of first and second engagement elements and to establish the lower speed through engagement of the first engagement element and a one-way clutch.

In order to achieve the foregoing main object, the control device and the control method for a transmission according to an exemplary embodiment adopt the following means.

Exemplary embodiments provide

a control device for a transmission capable of transferring power transferred from a motor mounted on a vehicle to an input shaft to an output shaft with a speed of the power changed at a speed ratio of a plurality of shift speeds established through engagement and disengagement of a plurality of engagement elements, the transmission being configured to establish a starting speed through engagement of first and second engagement elements to which a hydraulic pressure is supplied from a hydraulic control device, and to establish a lower speed having a speed ratio that is higher than that of the starting speed through engagement of the first engagement element and a one-way clutch, the control device including:

starting control means for engaging the first and second engagement elements such that the transmission establishes the starting speed by controlling the hydraulic control device when the vehicle is started, in which

the starting control means controls the hydraulic control device, with the starting speed established, so as to supply the first engagement element with a hydraulic pressure for maintaining an engaged state and supply the second engagement element with a hydraulic pressure for maintaining an engaged state and causing the second engagement element to slip as torque for shifting from the starting speed to the lower speed is input to the input shaft.

The control device for a transmission according to an exemplary embodiment includes starting control means for engaging the first and second engagement elements such that the transmission establishes the starting speed by controlling the hydraulic control device when the vehicle is started. The starting control means controls the hydraulic control device, with the starting speed established, so as to supply the first engagement element with a hydraulic pressure for maintaining an engaged state and supply the second engagement element with a hydraulic pressure for maintaining an engaged state and causing the second engagement element to slip as torque for shifting from the starting speed to the lower speed is input to the input shaft. In this way, by causing the second engagement element to slip as torque for shifting from the starting speed to the lower speed is input to the input shaft with the starting speed established, shifting from the starting speed to the lower speed is started automatically, that is, without judging whether or not the speed change condition is met, when the speed change condition for shifting from the starting speed to the lower speed is met in response to the drive force request from the driver, and the one-way clutch is engaged to establish the lower speed. Consequently, it is possible to promptly change the shift speed of the transmission from the starting speed to the lower speed in response to the drive force request from the driver after the vehicle is started.

In addition, the control device for a transmission discussed above, exemplary embodiments may further include disengagement control means for starting disengagement control for the second engagement element after detecting start of shifting to the lower speed on the basis of a rotational speed of the input shaft. In this way, by starting disengagement control for the second engagement element by the disengagement control means after start of shifting to the lower speed (variation in rotation from the rotational speed at the starting speed) is detected on the basis of the rotational speed of the input shaft, it is possible to suppress a continuous slip of the second engagement element after shifting from the second speed to the lower speed is started, and to promptly complete shifting from the starting speed to the lower speed.

Further, the disengagement control means may start the disengagement control for the second engagement element after the rotational speed of the input shaft becomes higher than a reference rotational speed determined by the speed ratio at the starting speed and a vehicle speed or a rotational speed of the output shaft. That is, it can be judged that shifting from the starting speed to the lower speed has been started with the second engagement element slipping if the rotational speed of the input shaft is higher than the reference rotational speed which is determined by the speed ratio at the starting speed and the vehicle speed or the rotational speed of the output shaft. Thus, if disengagement control for the second engagement element by the disengagement control means is started after the rotational speed of the input shaft becomes higher than the reference rotational speed, it is possible to favorably suppress a continuous slip of the second engagement element after shifting from the starting speed to the lower speed is started, and to promptly complete shifting from the starting speed to the lower speed to favorably meet the drive force request from the driver.

Moreover, the disengagement control means may start the disengagement control for the second engagement element after the rotational speed of the input shaft reaches a reference rotational speed determined by the speed ratio at the lower speed and a vehicle speed or a rotational speed of the output shaft. That is, it can be judged that shifting from the starting speed to the lower speed has been substantially completed if the rotational speed of the input shaft has reached the reference rotational speed which is determined by the speed ratio at the lower speed and the vehicle speed or the rotational speed of the output shaft. Thus, if disengagement control for the second engagement element by the disengagement control means is started after the rotational speed of the input shaft reaches the reference rotational speed, it is possible to complete shifting from the starting speed to the lower speed while favorably suppressing occurrence of a shock that accompanies disengagement of the second engagement element and engagement of the one-way clutch.

Furthermore, the disengagement control means may start the disengagement control for the second engagement element after a value obtained by subtracting the rotational speed of the input shaft from a reference rotational speed determined by the speed ratio at the lower speed and a vehicle speed or a rotational speed of the output shaft becomes equal to or less than a predetermined value. Consequently, it is possible to promptly complete shifting from the starting speed to the lower speed while suppressing occurrence of a shock that accompanies disengagement of the second engagement element and engagement of the one-way clutch.

In addition, the control device for a transmission according to exemplary embodiments may further include target torque capacity setting means for setting a first target torque capacity for the first engagement element and a second target torque capacity for the second engagement element with the starting speed established, and the target torque capacity setting means may set the second target torque capacity using a safety factor that is smaller than a safety factor used to set the first target torque capacity. In this way, by making the safety factor used to set the second target torque capacity smaller than the safety factor used to set the first target torque capacity, it is possible to easily set the second target torque capacity such that the second engagement element slips as the speed change condition is met with the starting speed engaged.

Further, with the starting speed established, the second engagement element may be kept engaged if torque output from the motor is equal to or less than maximum output torque at the starting speed which is based on torque that matches an accelerator operation amount and a vehicle speed on a downshift line for determining shifting from the starting speed to the lower speed, and the second engagement element may slip if the torque output from the motor exceeds the maximum output torque at the starting speed. Consequently, it is possible to adequately change the shift speed from the starting speed to the lower speed in response to the drive force request from the driver.

Moreover, the maximum output torque at the starting speed may be determined as torque that is smaller than output torque of the motor at the time when the accelerator operation amount is maximum with the starting speed established in the case where the vehicle speed is less than a predetermined vehicle speed, and may be determined as the output torque in the case where the vehicle speed is equal to or more than the predetermined vehicle speed.

Exemplary embodiments also provide

a control method for a transmission capable of transferring power transferred from a motor mounted on a vehicle to an input shaft to an output shaft with a speed of the power changed at a speed ratio of a plurality of shift speeds established through engagement and disengagement of a plurality of engagement elements, the transmission being configured to establish a starting speed through engagement of first and second engagement elements to which a hydraulic pressure is supplied from a hydraulic control device, and to establish a lower speed having a speed ratio that is higher than that of the starting speed through engagement of the first engagement element and a one-way clutch, the control method including:

(a) a step of engaging the first and second engagement elements such that the transmission establishes the starting speed by controlling the hydraulic control device when the vehicle is started, in which

the step (a) includes controlling the hydraulic control device, with the starting speed established, so as to supply the first engagement element with a hydraulic pressure for maintaining an engaged state and supply the second engagement element with a hydraulic pressure for maintaining an engaged state and causing the second engagement element to slip as torque for shifting from the starting speed to the lower speed is input to the input shaft.

With the control method for a transmission according to exemplary embodiments, it is possible to promptly change the shift speed of the transmission from the starting speed to the lower speed in response to the drive force request from the driver after the vehicle is started.

### BRIEF DESCRIPTION OF THE DRAWINGS

FIG. 1 illustrates a schematic configuration of an automobile 10 incorporating a power transfer device 20 including an automatic transmission 25 controlled by a control device according to the exemplary embodiments.

FIG. 2 illustrates a schematic configuration of the power transfer device 20.

FIG. 3 is an operation table illustrating the relationship between each shift speed of the automatic transmission 25 and the respective operating states of clutches and brakes.

FIG. 4 is a velocity diagram illustrating the relationship between the respective rotational speeds of rotary elements that constitute the automatic transmission 25.

FIG. 5 is a system diagram illustrating a hydraulic control device 50.

FIG. 6 illustrates an example of a speed change map.

FIG. 7 is a flowchart illustrating an example of a starting control routine executed by a speed change ECU 21 which is the control device according to the exemplary embodiments.

FIG. 8 illustrates an example of a second speed maximum engine torque map.

FIG. 9 is a time chart illustrating how a hydraulic pressure command value Psl4* for a fourth linear solenoid valve, an input rotational speed Nin, and so forth vary when the starting control routine of FIG. 7 is executed.

### DESCRIPTION

Now, an embodiment will be described with reference to the drawings.

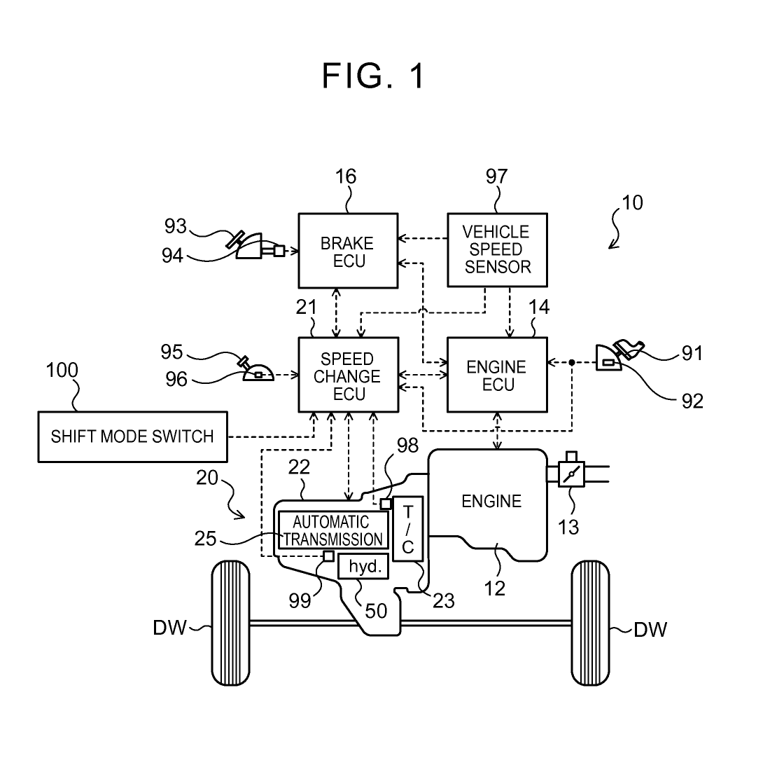

FIG. 1 illustrates a schematic configuration of an automobile 10 incorporating a power transfer device 20 including an automatic transmission 25 controlled by a control device according to an exemplary embodiment. The automobile 10 illustrated in the drawing includes: an engine (internal combustion engine) 12 that serves as a motor that outputs power through explosive combustion of a mixture of a hydrocarbon fuel, such as gasoline and light oil, and air; an engine electronic control unit (hereinafter referred to as an “engine ECU”) 14 that controls the engine 12; a brake electronic control unit (hereinafter referred to as a “brake ECU”) 16 that controls an electronically controlled hydraulic brake unit (not illustrated); a power transfer device 20 connected to the engine 12 to transfer power from the engine 12 to left and right drive wheels DW; and so forth. The power transfer device 20 includes a transmission case 22, a fluid transmission device 23, the automatic transmission 25, a hydraulic control device 50, a speed change electronic control unit (hereinafter referred to as a “speed change ECU”) 21 that controls such components and that serves as the control device in the present embodiment, and so forth.

The engine ECU 14 is structured as a microcomputer including a CPU (not illustrated) as a main component, and has a ROM that stores various programs, a RAM that temporarily stores data, input and output ports and a communication port (not illustrated), and so forth besides the CPU. As illustrated in FIG. 1, the engine ECU 14 receives inputs such as an accelerator operation amount Acc from an accelerator pedal position sensor 92 that detects the amount of depression (amount of operation) of an accelerator pedal 91, a vehicle speed V from a vehicle speed sensor 97, signals from various sensors such as a crankshaft position sensor (not illustrated) that detects the rotational position of a crankshaft, and signals from the brake ECU 16 and the speed change ECU 21. The engine ECU 14 controls an electronically controlled throttle valve 13, and a fuel injection valve, an ignition plug, and so forth (not illustrated) on the basis of the received signals. In addition, the engine ECU 14 calculates a rotational speed Ne of the engine 12 on the basis of the rotational position of the crankshaft detected by the crankshaft position sensor. Further, the engine ECU 14 calculates engine torque Te, which is an estimated value of torque output from the engine 12, on the basis of the rotational speed Ne, the intake air amount of the engine 12 detected by an air flow meter (not illustrated) or a throttle opening THR of the throttle valve 13, and a map or calculation formula determined in advance, for example.

The brake ECU 16 is also structured as a microcomputer including a CPU (not illustrated) as a main component, and has a ROM that stores various programs, a RAM that temporarily stores data, input and output ports and a communication port (not illustrated), and so forth besides the CPU. As illustrated in FIG. 1, the brake ECU 16 receives inputs such as a master cylinder pressure detected by a master cylinder pressure sensor 94 when a brake pedal 93 is depressed, the vehicle speed V from the vehicle speed sensor 97, signals from various sensors (not illustrated), and signals from the engine ECU 14 and the speed change ECU 21. The brake ECU 16 controls a brake actuator (hydraulic actuator) (not illustrated) etc. on the basis of the received signals.

The speed change ECU 21 is also structured as a microcomputer including a CPU (not illustrated) as a main component, and includes a ROM that stores various programs, a RAM that temporarily stores data, input and output ports and a communication port (not illustrated), and so forth besides the CPU. As illustrated in FIG. 1, the speed change ECU 21 receives inputs such as the accelerator operation amount Acc from the accelerator pedal position sensor 92, a shift range SR from a shift range sensor 96 that detects the operating position of a shift lever 95 for selecting a desired shift range from a plurality of shift ranges, a signal from a shift mode switch 100 for selecting a desired shift mode from a plurality of shift modes (control modes) of the automatic transmission 25, the vehicle speed V from the vehicle speed sensor 97, signals from various sensors such as an input rotational speed sensor 98 that detects an input rotational speed Nin of the automatic transmission 25 (the rotational speed of a turbine runner 23t or an input shaft 26 of the automatic transmission 25) and an output rotational speed sensor 99 that detects an output rotational speed Nout of the automatic transmission 25 (the rotational speed of an output shaft 27), and signals from the engine ECU 14 and the brake ECU 16. The speed change ECU 21 controls the fluid transmission device 23 and the automatic transmission 25, that is, the hydraulic control device 50, on the basis of the received signals.

In the embodiment, the shift range SR of the shift lever 95 includes a parking range used to park the vehicle, a reverse range for reverse travel, a neutral range, and a normal drive range for forward travel. In addition, the shift mode of the automatic transmission 25 that can be selected using the shift mode switch 100 includes a normal mode in which upshifting is executed promptly with stress on improving the fuel efficiency, a sports mode in which upshifting is delayed and downshifting is advanced compared to the normal mode to improve the response of torque output to the output shaft 27, and a comfort mode for executing shifting with priority given to the comfort of passengers compared to the normal mode. The speed change ECU 21 sets a shift mode flag Fsm to a value that matches the shift mode selected by a driver on the basis of the signal from the shift mode switch 100, and stores the set value in the RAM (not illustrated).

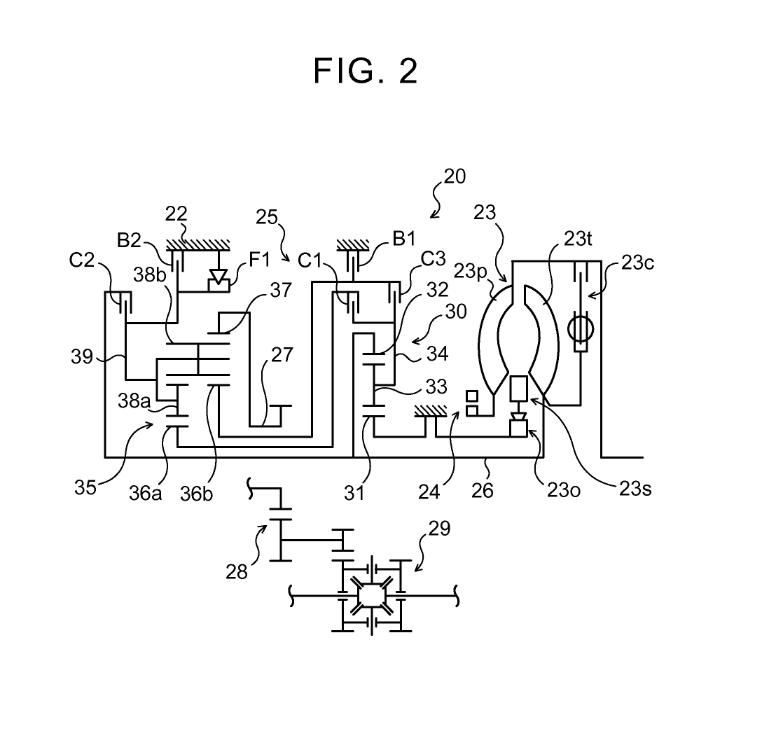

The fluid transmission device 23 of the power transfer device 20 is structured as a torque converter that has a torque amplification function. As illustrated in FIG. 2, the fluid transmission device 23 includes a pump impeller 23p on the input side connected to the crankshaft of the engine 12, the turbine runner 23t on the output side connected to the input shaft (input member) 26 of the automatic transmission 25, a stator 23s disposed on the inner side of the pump impeller 23p and the turbine runner 23t to rectify the flow of working oil (ATF) from the turbine runner 23t to the pump impeller 23p, a one-way clutch 23o that restricts rotation of the stator 23s to one direction, a lock-up clutch 23c, and so forth. An oil pump (mechanical pump) 24 is structured as a gear pump that includes a pump assembly composed of a pump body and a pump cover, an externally toothed gear connected to the pump impeller 23p of the fluid transmission device 23 via a hub, and so forth. When the externally toothed gear is rotated by power from the engine 12, the oil pump 24 suctions working oil reserved in an oil pan (not illustrated) to pump the working oil to the hydraulic control device 50.

The automatic transmission 25 is structured as a 6-speed transmission. As illustrated in FIG. 2, the automatic transmission 25 includes a single-pinion type planetary gear mechanism 30, a Ravigneaux type planetary gear mechanism 35, three clutches C1, C2, and C3, two brakes B1 and B2, and a one-way clutch F1 that change a power transfer path from the input side to the output side, and so forth. The single-pinion type planetary gear mechanism 30 has a sun gear 31 which is an externally toothed gear held stationary with respect to the transmission case 22, a ring gear 32 which is an internally toothed gear disposed concentrically with the sun gear 31 and connected to the input shaft 26, a plurality of pinion gears 33 meshed with the sun gear 31 and meshed with the ring gear 32, and a carrier 34 that rotatably and revolvably holds the plurality of pinion gears 33.

The Ravigneaux type planetary gear mechanism 35 includes two sun gears 36a and 36b which are each an externally toothed gear, a ring gear 37 which is an internally toothed gear held stationary with respect to the output shaft (output member) 27 of the automatic transmission 25, a plurality of short pinion gears 38a meshed with the sun gear 36a, a plurality of long pinion gears 38b meshed with the sun gear 36b and the plurality of short pinion gears 38a and meshed with the ring gear 37, and a carrier 39 that rotatably and revolvably holds the plurality of short pinion gears 38a and the plurality of long pinion gears 38b, which are coupled to each other, and that is supported by the transmission case 22 via the one-way clutch F1. The output shaft 27 of the automatic transmission 25 is connected to the drive wheels DW via a gear mechanism 28 and the differential mechanism 29.

The clutch C1 is a multi-plate friction-type hydraulic clutch (friction engagement element) that has a hydraulic servo structured from a piston, a plurality of friction plates and mating plates, an oil chamber supplied with working oil, and so forth, and that is capable of fastening and unfastening the carrier 34 of the single-pinion type planetary gear mechanism 30 and the sun gear 36a of the Ravigneaux type planetary gear mechanism 35 to and from each other. The clutch C2 is a multi-plate friction-type hydraulic clutch that has a hydraulic servo structured from a piston, a plurality of friction plates and mating plates, an oil chamber supplied with working oil, and so forth, and that is capable of fastening and unfastening the input shaft 26 and the carrier 39 of the Ravigneaux type planetary gear mechanism 35 to and from each other. The clutch C3 is a multi-plate friction-type hydraulic clutch that has a hydraulic servo structured from a piston, a plurality of friction plates and mating plates, an oil chamber supplied with working oil, and so forth, and that is capable of fastening and unfastening the carrier 34 of the single-pinion type planetary gear mechanism 30 and the sun gear 36b of the Ravigneaux type planetary gear mechanism 35 to and from each other.

The brake B1 is a hydraulic brake that is structured as a band brake or a multi-plate friction-type brake including a hydraulic servo, and that is capable of making the sun gear 36b of the Ravigneaux type planetary gear mechanism 35 stationary and movable with respect to the transmission case 22. The brake B2 is a hydraulic brake that is structured as a band brake or a multi-plate friction-type brake including a hydraulic servo, and that is capable of making the carrier 39 of the Ravigneaux type planetary gear mechanism 35 stationary and movable with respect to the transmission case 22. In addition, the one-way clutch F1 includes an inner race, an outer race, a plurality of sprags, and so forth, for example. The one-way clutch F1 transfers torque via the sprags when the outer race rotates in one direction with respect to the inner race, and allows the inner race and the outer race to rotate with respect to each other when the outer race rotates in the other direction with respect to the inner race. It should be noted, however, that the one-way clutch F1 may be of a roller type or the like, rather than the sprag type.

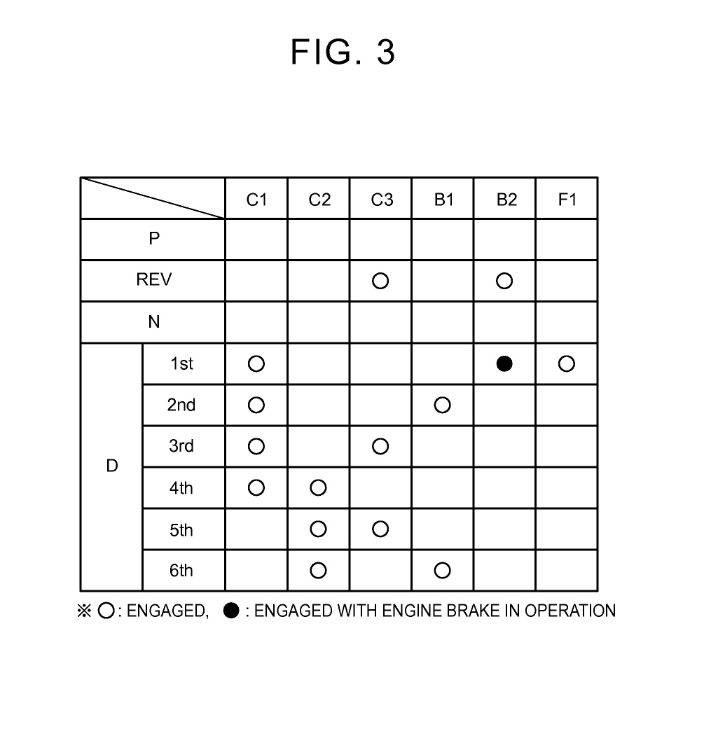

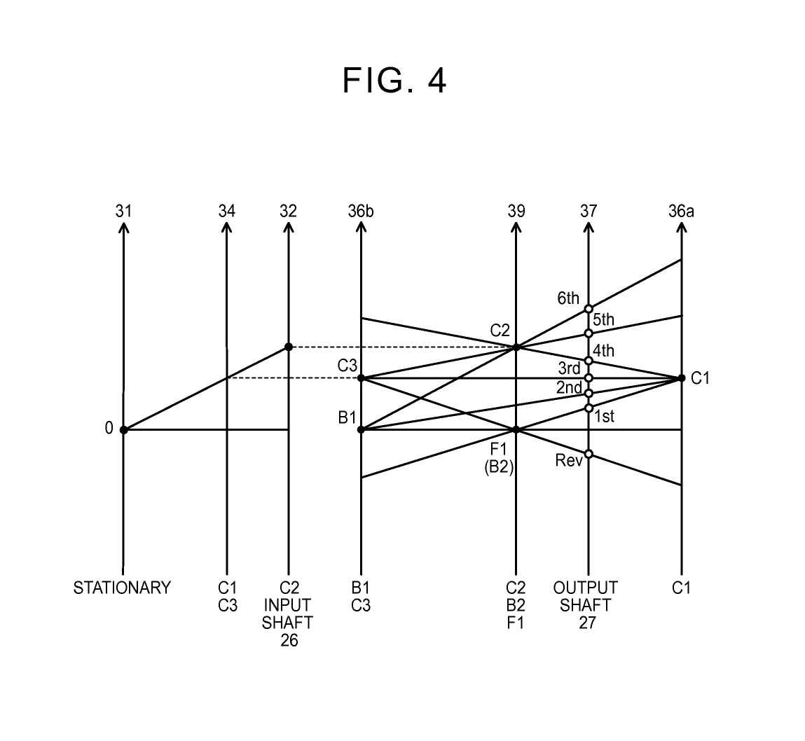

The clutches C1 to C3 and the brakes B1 and B2 operate with working oil supplied thereto and discharged therefrom by the hydraulic control device 50. FIG. 3 is an operation table illustrating the relationship between each shift speed of the automatic transmission 25 and the respective operating states of the clutches C1 to C3 and the brakes B1 and B2. FIG. 4 is a velocity diagram illustrating the relationship between the respective rotational speeds of rotary elements constituting the automatic transmission 25. The automatic transmission 25 provides first to sixth forward speeds and a reverse speed when the clutches C1 to C3 and the brakes B1 and B2 are brought into respective states illustrated in the operation table of FIG. 3. As illustrated in FIG. 3, the first speed (lower speed) of the automatic transmission 25 is established by engaging the one-way clutch F1 with the clutch C1 engaged. In addition, the second speed (starting speed) is established by engaging the clutch C1 and engaging the brake B1. The third and fourth speeds are established by engaging the clutch C1 and engaging one of the clutches C2 and C3. Further, the fifth and sixth speeds of the automatic transmission 25 are established by engaging the clutch C2 and engaging one of the clutch C3 and the brake B1. At least one of the clutches C1 to C3 and the brake B2, which does not include the brake B1, may be a meshing engagement element such as a dog clutch.

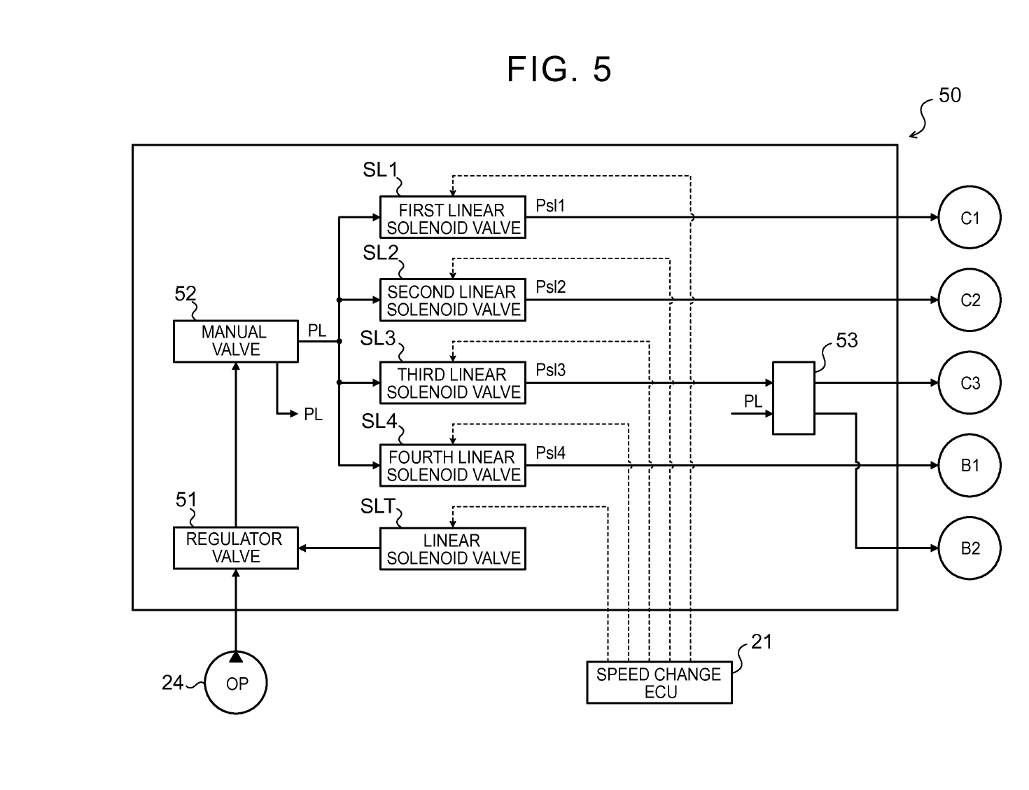

FIG. 5 is a system diagram illustrating the hydraulic control device 50. The hydraulic control device 50 is connected to the oil pump 24 discussed above which is driven by power from the engine 12 to suction working oil from the oil pan to discharge the working oil, and generates a hydraulic pressure required for the fluid transmission device 23 and the automatic transmission 25 and supplies the working oil to portions to be lubricated such as various bearings. The hydraulic control device 50 includes: a valve body (not illustrated); a primary regulator valve 51 that regulates the pressure of working oil from the oil pump 24 to generate a line pressure PL; a manual valve 52 that switches the supply destination of the line pressure PL from the primary regulator valve 51 in accordance with the operating position of the shift lever 95; an application control valve 53; and a first linear solenoid valve SL1, a second linear solenoid valve SL2, a third linear solenoid valve SL3, a fourth linear solenoid valve SL4, and so forth that serve as pressure regulation valves that regulate the line pressure PL as a source pressure supplied from the manual valve 52 or the like (primary regulator valve 51) to generate a hydraulic pressure for the corresponding clutch etc., respectively.

The primary regulator valve 51 is driven by a hydraulic pressure from a linear solenoid valve SLT controlled by the speed change ECU 21 so as to regulate the pressure of hydraulic oil from the oil pump 24 side (for example, a modulator valve that regulates the line pressure PL to output a constant hydraulic pressure) in accordance with the accelerator operation amount Acc or the throttle opening THR of the throttle valve 13. The manual valve 52 has a spool that is axially slidable in conjunction with the shift lever 95, an input port to which the line pressure PL is supplied, a drive range output port that communicates with respective input ports of the first to fourth linear solenoid valves SL1 to SL4 via an oil passage, a reverse range output port, and so forth (none of which is illustrated). When the driver selects the drive range, the line pressure (drive range pressure) PL from the primary regulator valve 51 is supplied to the first to fourth linear solenoid valves SL1 to SL4 as a source pressure via the drive range output port of the manual valve 52. When the driver selects the reverse range, meanwhile, the spool of the manual valve 52 allows the input port to communicate with only the reverse range output port. When the driver selects the parking range or the neutral range, communication between the input port of the manual valve 52 and the drive range output port and the reverse range output port is blocked.

The application control valve 53 is a spool valve capable of selectively establishing: a first state in which a hydraulic pressure from the third linear solenoid valve SL3 is supplied to the clutch C3; a second state in which the line pressure PL from the primary regulator valve 51 is supplied to the clutch C3 and the line pressure PL (reverse range pressure) from the reverse range output port of the manual valve 52 is supplied to the brake B2; a third state in which the line pressure PL (reverse range pressure) from the reverse range output port of the manual valve 52 is supplied to the clutch C3 and the brake B2; and a fourth state in which a hydraulic pressure from the third linear solenoid valve SL3 is supplied to the brake B2.

The first linear solenoid valve SL1 is a normally closed linear solenoid valve that can regulate the line pressure PL from the manual valve 52 in accordance with an applied current to generate a hydraulic pressure Psl1 for the clutch C1. The second linear solenoid valve SL2 is a normally closed linear solenoid valve that can regulate the line pressure PL from the manual valve 52 in accordance with an applied current to generate a hydraulic pressure Psl2 for the clutch C2. The third linear solenoid valve SL3 is a normally closed linear solenoid valve that can regulate the line pressure PL from the manual valve 52 in accordance with an applied current to generate a hydraulic pressure Psl3 for the clutch C3 or the brake B2. The fourth linear solenoid valve SL4 is a normally closed linear solenoid valve that can regulate the line pressure PL from the manual valve 52 in accordance with an applied current to generate a hydraulic pressure Psl4 for the brake B1. That is, hydraulic pressures for the clutches C1 to C3 and the brakes B1 and B2 which are friction engagement elements of the automatic transmission 25 are directly controlled (set) by the corresponding first, second, third, and fourth linear solenoid valves SL1, SL2, SL3, and SL4.

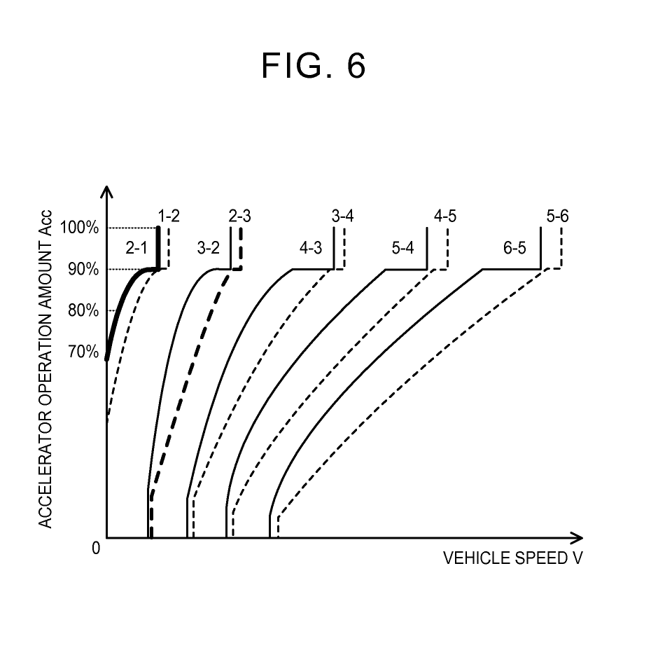

The first to fourth linear solenoid valves SL1 to SL4 discussed above (respective currents applied thereto) are controlled by the speed change ECU 21. That is, when the shift speed is changed, that is, when an upshift or a downshift is performed, the speed change ECU 21 acquires a target shift speed corresponding to the accelerator operation amount Acc (or the throttle opening THR of the throttle valve 13 of the engine 12) and the vehicle speed V from a speed change map determined in advance, and controls the first to fourth linear solenoid valves SL1 to SL4 such that the acquired target shift speed is established. FIG. 6 illustrates an example of the speed change map. In the speed change map illustrated in the drawing, the solid lines are prescribed by operating points defined by the accelerator operation amount Acc and the vehicle speed V at which a downshift should be executed, and the broken lines are prescribed by operating points defined by the accelerator operation amount Acc and the vehicle speed V at which an upshift should be executed.

In the embodiment, in addition, the speed change map has been prepared such that the target shift speed is basically set to the second speed when starting the automobile 10 for the purpose of suppressing a rise in rotational speed Ne of the engine 12 to improve the fuel efficiency, for example. Thus, the speed change ECU 21 controls the first and fourth linear solenoid valves SL1 and SL4 such that the second speed as the starting speed is established through engagement of the clutch C1 and the brake B1 when the driver operates the shift lever 95 to change the shift range SR from the parking range or the like to the drive range for forward travel, during a period since the automobile 10 decelerates to be stationary until the automobile 10 restarts, or the like. Then, after the automobile 10 is started with the second speed of the automatic transmission 25 established, and in the case where the operating point defined by the accelerator operation amount Acc and the vehicle speed V moves from the right side or the lower side, in the drawing, of a 2-1 downshift line indicated by the thick solid line in FIG. 6 to the left side or the upper side, in the drawing, of the 2-1 downshift line, a speed change condition for shifting from the second speed as the starting speed to the first speed as the lower speed is met so that the target shift speed is changed from the second speed to the first speed. Further, in the case where the operating point defined by the accelerator operation amount Acc and the vehicle speed V moves from the left side or the upper side, in the drawing, of a 2-3 upshift line indicated by the thick broken line in FIG. 6, or from a location on the 2-3 upshift line, to the right side or the lower side, in the drawing, of the 2-3 upshift line, a speed change condition for shifting from the second speed as the starting speed to the third speed as the higher speed is met so that the target shift speed is changed from the second speed to the third speed.

The speed change ECU 21 sets a hydraulic pressure command value Psl1* to Psl4* for one of the first to fourth linear solenoid valves SL1 to SL4 corresponding to a clutch or a brake (engagement-side element) to be engaged along with the change between shift speeds such that the target shift speed acquired from the speed change map discussed above is established. In addition, the speed change ECU 21 sets a hydraulic pressure command value Psl1* to Psl4* for one of the first to fourth linear solenoid valves SL1 to SL4 corresponding to a clutch or a brake to be disengaged along with the change between shift speeds when the shift speed is changed, that is, an upshift or a downshift is performed. Further, the speed change ECU 21 sets a hydraulic pressure command value Psl1* to Psl4* for one or two of the first to fourth linear solenoid valves SL1 to SL4 corresponding to a clutch or a brake (engagement-side element) being engaged while the shift speed is changed or after shifting is completed. Then, the speed change ECU 21 controls a drive circuit (not illustrated) that sets currents to the first to fourth linear solenoid valves SL1 to SL4 on the basis of the set hydraulic pressure command values Psl1* to Psl4*.

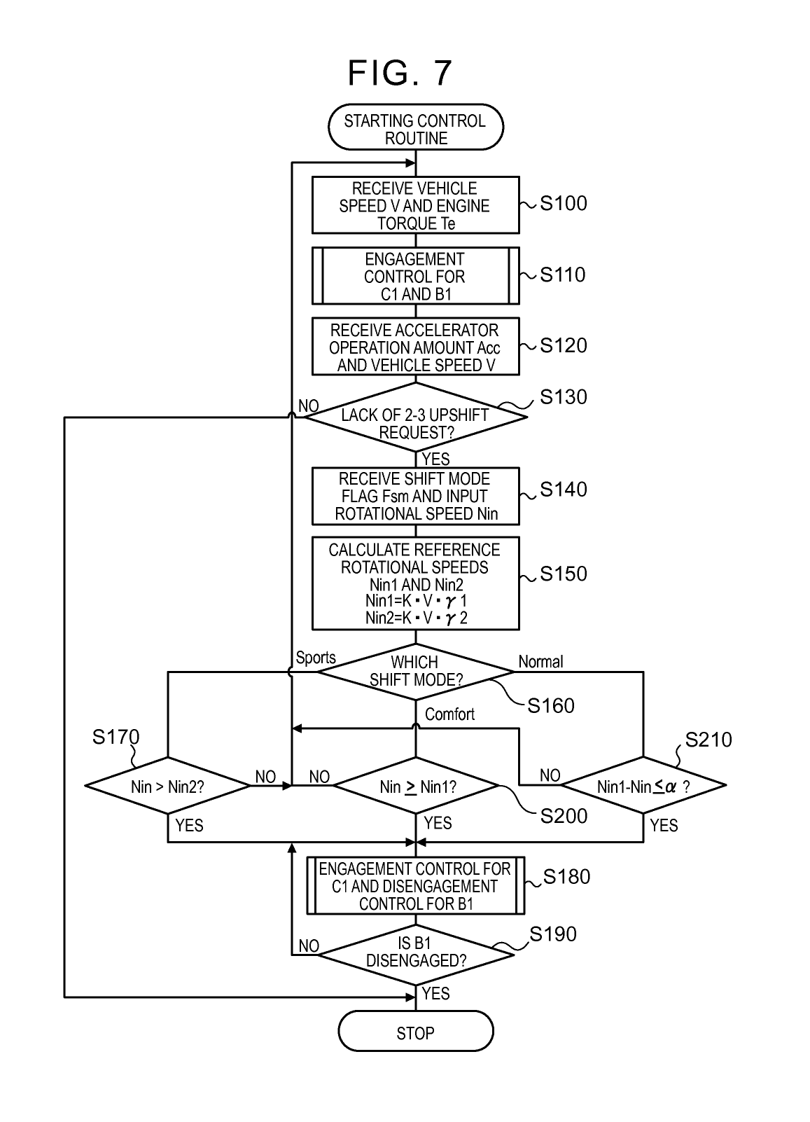

Next, the control procedure for the automatic transmission 25 at the time when the automobile 10 is started will be described with reference to FIGS. 7 to 9.

FIG. 7 is a flowchart illustrating an example of a starting control routine started by the speed change ECU 21 when the second speed of the automatic transmission 25 is established through engagement of the clutch C1 and the brake B1 in order to start the automobile 10 in accordance with a change from the parking range or the like to the drive range or the like. When starting the starting control routine, the speed change ECU 21 first receives the vehicle speed V from the vehicle speed sensor 97 and the engine torque Te calculated by the engine ECU 14 (step S100). Then, the speed change ECU 21 executes engagement control for engaging the clutch C1 and the brake B1 on the basis of the vehicle speed V and the engine torque Te such that the second speed of the automatic transmission 25 is established (held) (step S110).

In the engagement control for the clutch C1, a target torque capacity (first target torque capacity) Tc1 for the clutch C1 is set, and the first linear solenoid valve SL1 is controlled such that the clutch C1 is engaged with the target torque capacity Tc1. In step S110, the speed change ECU 21 sets the target torque capacity Tc1 to the product of the engine torque Te input in step S100, a torque distribution ratio for the clutch C1, and a safety factor (e.g. a value of 1.2 to 1.4). The torque distribution ratio indicates the proportion of torque to be transferred from the engine 12 to the output shaft 27 of the automatic transmission 25 by a clutch or a brake that is engaged to establish a certain shift speed to the engine torque Te (input torque of the automatic transmission 25). In the embodiment, a torque distribution ratio map (not illustrated) that prescribes the torque distribution ratio of a clutch or a brake that is engaged to establish a shift speed has been prepared in advance for each shift speed of the automatic transmission 25, and the torque distribution ratio for the clutch C1 for establishing the second speed is acquired from the torque distribution ratio map. Then, the speed change ECU 21 sets the hydraulic pressure command value Psl1* for the first linear solenoid valve SL1 which matches the target torque capacity Tc1, and controls the drive circuit (not illustrated) discussed above on the basis of the set hydraulic pressure command value Psl1* to engage the clutch C1 (keep the clutch C1 engaged) so as to provide the target torque capacity Tc1.

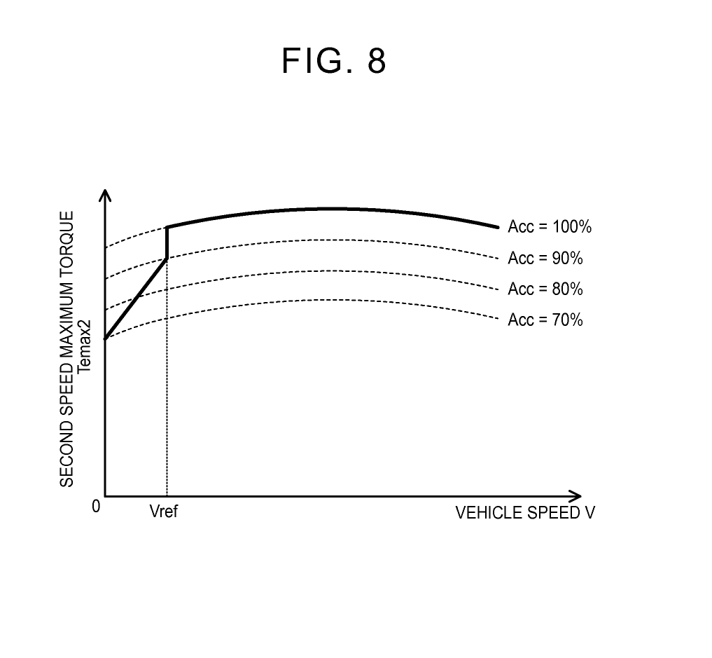

In the engagement control for the brake B1, meanwhile, a target torque capacity (second target torque capacity) Tb1 for the brake B1 is set, and the fourth linear solenoid valve SL4 is controlled such that the brake B1 is engaged with the target torque capacity Tb1. In step S110, the speed change ECU 21 acquires second speed maximum torque Temax2 corresponding to the vehicle speed V input in step S100, that is, the current vehicle speed V, from the second speed maximum engine torque map illustrated in FIG. 8, and sets the target torque capacity Tb1 to the product of the acquired second speed maximum torque Temax2, the torque distribution ratio for the brake B1, and a safety factor.

The second speed maximum engine torque map illustrated in FIG. 8 has been prepared in advance so as to prescribe the relationship between the vehicle speed V at the time when the second speed is established and the second speed maximum torque Temax2 (maximum output torque at the starting speed), which is the maximum value of torque output from the engine 12 when the second speed is established, on the basis of torque output from the engine 12 at an operating point (the vehicle speed V and the accelerator operation amount Acc) on the 2-1 downshift line in the speed change map of FIG. 6. In the embodiment, as illustrated in the drawing, the second speed maximum torque Temax2 is determined to be less than the output torque of the engine 12 at the time when the accelerator operation amount Acc is maximum (100%) with the second speed established in the case where the vehicle speed V is less than a predetermined vehicle speed Vref, and determined to be the output torque of the engine 12 at the time when the accelerator operation amount Acc is maximum (100%) with the second speed established in the case where the vehicle speed V is equal to or more than the predetermined vehicle speed Vref. It should be noted, however, that the second speed maximum engine torque map may be prepared in advance so as to prescribe the relationship between the output rotational speed Nout and the second speed maximum torque Temax2. In this case, in step S100, the output rotational speed Nout from the output rotational speed sensor 99 should be received in place of the vehicle speed V. In addition, the torque distribution ratio for the brake B1 is acquired from the torque distribution ratio map (not illustrated) discussed above. Further, the safety factor used to set the target torque capacity Tb1 is determined to be smaller (e.g. a value of 1.0 to 1.1) than that used to set the target torque capacity Tc1, and has a value of 1.0 in the embodiment. Then, the speed change ECU 21 sets the hydraulic pressure command value Psl4* for the fourth linear solenoid valve SL1 which matches the target torque capacity Tb1, and controls the drive circuit (not illustrated) discussed above on the basis of the set hydraulic pressure command value Psl4* to engage the brake B1 (keep the brake B1 engaged) so as to provide the target torque capacity Tb1. The target torque capacity Tc1 for the clutch C1 may be set to the product of the second speed maximum torque Temax2, the torque distribution ratio for the clutch C1, and the safety factor if a sufficiently large value is used as the safety factor.

The automobile 10 can be caused to travel (started) with the clutch C1 and the brake B1 engaged (kept engaged) through the engagement control in step S110 discussed above to establish the second speed of the automatic transmission 25. In addition, the clutch C1 can be favorably maintained in the engaged state by setting the target torque capacity Tc1 for the clutch C1 as discussed above. Further, as discussed above, the target torque capacity Tb1 for the brake B1 is set to the product of the second speed maximum torque Temax2 corresponding to the current vehicle speed V, the torque distribution ratio for the brake B1, and the safety factor (a value of 1.0). Thus, if the operating point defined by the accelerator operation amount Acc and the vehicle speed V is located on the 2-1 downshift line indicated in the speed change map of FIG. 6, or on the right side or the lower side, in the drawing, of the 2-1 downshift line, after the automobile 10 is started, the shift speed of the automatic transmission 25 can be maintained at the second speed by engaging the brake B1 (maintaining the brake B1 in the engaged state).

If the operating point defined by the accelerator operation amount Acc and the vehicle speed V moves to the left side or the upper side, in the drawing, of the 2-1 downshift line indicated in the speed change map of FIG. 6 when the driver requests a larger drive force by depressing the accelerator pedal 91 after the automobile 10 is started, in contrast, the speed change condition for shifting from the second speed to the first speed is met, and the output torque of the engine 12 becomes larger than the second speed maximum torque Temax2 discussed above (torque for shifting from the second speed to the first speed is input to the input shaft 26). Consequently, in the automatic transmission 25, when the speed change condition for shifting from the second speed to the first speed is met, the torque capacity of the brake B1 becomes insufficient with respect to an increase in output torque of the engine 12, that is, an increase in torque input to the input shaft 26, and the brake B1 slips. In this event, in addition, the clutch C1 is maintained in the engaged state with the target torque capacity Tc1 set as discussed above, and the one-way clutch F1 is engaged because of the slip of the brake B1. Thus, in the automatic transmission 25, the shift speed can be automatically changed from the second speed to the first speed in accordance with the establishment of the speed change condition for shifting from the second speed to the first speed. As a result, in the automatic transmission 25, it is possible to promptly change the shift speed from the second speed as the starting speed to the first speed as the lower speed in response to the drive force request from the driver after the automobile 10 is started compared to a case where it is determined whether or not to change the shift speed from the second speed to the first speed using the speed change map or the like and disengagement control for the brake B1 is started in accordance with the determination result.

After the process in step S110, the speed change ECU 21 receives the accelerator operation amount Acc from the accelerator pedal position sensor 92 and the vehicle speed V from the vehicle speed sensor 97 (step S120), and determines, on the basis of the received accelerator operation amount Acc and vehicle speed V and the speed change map of FIG. 6, whether or not the target shift speed for the automatic transmission 25 has been set to the third speed, that is, whether or not an upshift from the second speed to the third speed has been requested (step S130). In the case where it is determined in step S120 that an upshift from the second speed to the third speed is requested, the speed change ECU 21 ends the routine, and executes speed change control for changing the shift speed of the automatic transmission 25 from the second speed to the third speed.

In the case where it is determined in step S120 that an upshift from the second speed to the third speed has not been requested, on the other hand, the speed change ECU 21 receives the input rotational speed Nin from the input rotational speed sensor 98 and the value of the shift mode flag Fsm stored in the RAM (step S140). Further, the speed change ECU 21 calculates a first reference rotational speed Nin1 and a second reference rotational speed Nin2 from the vehicle speed V input in step S120, gear ratios γ1 and γ2 of the first speed and the second speed, respectively, of the automatic transmission 25, and a conversion coefficient K which is based on a final speed reduction ratio γf of the gear mechanism 28 and the differential mechanism 29, the outside diameter of the tires, and so forth (step S150). The first reference rotational speed Nin1 indicates the rotational speed of the input shaft 26 with the automobile 10 traveling with the first speed of the automatic transmission 25 established and at the current vehicle speed V, and is calculated as Nin1=K·V·γ1. Meanwhile, the second reference rotational speed Nin2 indicates the rotational speed of the input shaft 26 with the automobile 10 traveling with the second speed of the automatic transmission 25 established and at the current vehicle speed V, and is calculated as Nin2=K·V·γ2. In step 150, the first and second reference rotational speeds Nin1 and Nin2 may be calculated using the output rotational speed Nout of the automatic transmission 25 in place of the vehicle speed V.

Subsequently, the speed change ECU 21 determines, on the basis of the value of the shift mode flag Fsm input in step S140, which of the sports mode, the normal mode, and the comfort mode is selected by the driver as the shift mode (step S160). In the case where it is determined in step S160 that the sports mode is selected by the driver, the speed change ECU 21 determines whether or not the input rotational speed Nin of the automatic transmission 25 received in step S140 is higher than the second reference rotational speed Nin2 calculated in step S150 (step S170). In the case where it is determined in step S170 that the input rotational speed Nin is not higher than the second reference rotational speed Nin2, the speed change ECU 21 executes the processes in and after step S100 discussed above again. In the case where it is determined in step S170 that the input rotational speed Nin is higher than the second reference rotational speed Nin2, in contrast, the speed change ECU 21 executes engagement control for the clutch C1 as in step S110, and starts disengagement control for the brake B1 in which the hydraulic pressure command value Psl4* for the fourth linear solenoid valve SL4 is set such that the brake B1 is disengaged (step S180). The speed change ECU 21 executes the engagement control for the clutch C1 and the disengagement control for the brake B1 until it is determined in step S190 that the brake B1 has been completely disengaged. Then, if it is determined in step S190 that the brake B1 has been completely disengaged, the speed change ECU 21 ends the routine, and starts normal speed change control in which the target torque capacity Tb1 for the brake B1 is not set as discussed above.

In the case where it is determined in step S160 that the comfort mode is selected by the driver, meanwhile, the speed change ECU 21 determines whether or not the input rotational speed Nin of the automatic transmission 25 received in step S140 is equal to or more than the first reference rotational speed Nin1 calculated in step S150 (step S200). In the case where it is determined in step S200 that the input rotational speed Nin is not equal to or more than the first reference rotational speed Nin1, the speed change ECU 21 executes the processes in and after step S100 discussed above again. In the case where it is determined in step S200 that the input rotational speed Nin is equal to or more than the first reference rotational speed Nin1, in contrast, the speed change ECU 21 executes engagement control for the clutch C1 as in step S110, and starts disengagement control for the brake B1 (step S180). Also in this case, the speed change ECU 21 executes the engagement control for the clutch C1 and the disengagement control for the brake B1 until it is determined in step S190 that the brake B1 has been completely disengaged. Then, if it is determined in step S190 that the brake B1 has been completely disengaged, the speed change ECU 21 ends the routine, and starts normal speed change control in which the target torque capacity Tb1 for the brake B1 is not set as discussed above.

In the case where it is determined in step S160 that the normal mode is selected by the driver, further, the speed change ECU 21 determines whether or not a value obtained by subtracting the input rotational speed Nin of the automatic transmission 25 received in step S140 from the first reference rotational speed Nin1 calculated in step S150 is equal to or less than a predetermined value a (e.g. a value of about 50 rpm) (step S210). In the case where it is determined in step S210 that the value obtained by subtracting the input rotational speed Nin from the first reference rotational speed Nin1 is not equal to or less than the predetermined value a, the speed change ECU 21 executes the processes in and after step S100 discussed above again. In the case where it is determined in step S210 that the value obtained by subtracting the input rotational speed Nin from the first reference rotational speed Nin1 is equal to or less than the predetermined value a, in contrast, the speed change ECU 21 executes engagement control for the clutch C1 as in step S110, and starts disengagement control for the brake B1 (step S180). Also in this case, the speed change ECU 21 executes the engagement control for the clutch C1 and the disengagement control for the brake B1 until it is determined in step S190 that the brake B1 has been completely disengaged. Then, if it is determined in step S190 that the brake B1 has been completely disengaged, the speed change ECU 21 ends the routine, and starts normal speed change control in which the target torque capacity Tb1 for the brake B1 is not set as discussed above.

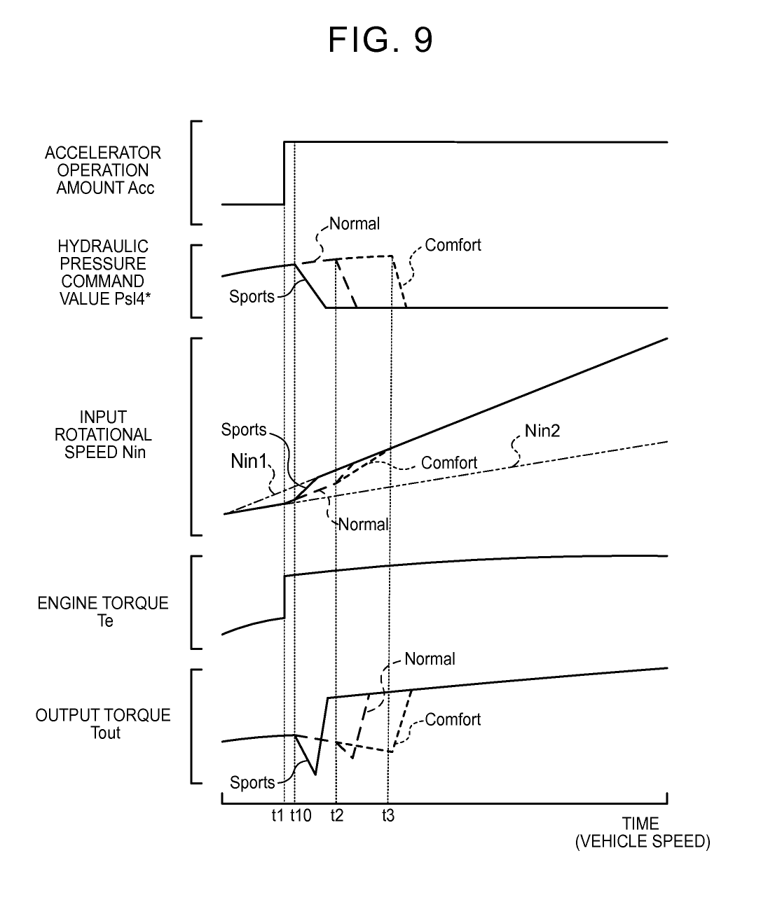

As a result of executing the starting control routine discussed above, in the automatic transmission 25, when the speed change condition for shifting from the second speed to the first speed is met with the accelerator pedal 91 depressed by the driver after the automobile 10 is started, and the brake B1 slips as the speed change condition is met, a change in shift speed from the second speed to the first speed is started (at time t1 in FIG. 9), and the one-way clutch is engaged to complete shifting from the second speed to the first speed to establish the first speed. Then, along with shifting from the second speed to the first speed, the input rotational speed Nin of the automatic transmission 25 exceeds the second reference rotational speed Nin2 discussed above, and approaches the first reference rotational speed Nin1 discussed above.

Here, if the brake B1 continuously slips more than necessary, it may take much time to complete shifting from the second speed to the first speed, friction materials etc. that constitute the brake B1 may produce heat, and a large drag loss may be caused. Thus, after the brake B1 slips as the speed change condition for shifting from the second speed to the first speed is met, it is necessary to start disengagement control for the brake B1. If disengagement control for the brake B1 is started without variation at the time when the brake B1 slips, however, a shock due to fluctuations in output torque Tout of the automatic transmission 25 that accompany disengagement of the brake B1 and engagement of the one-way clutch F1 may become manifest while the drive force request from the driver can be favorably met.

In the light of this, in the automatic transmission 25, the timing to start disengagement control for the brake B1 is changed in accordance with the shift mode as discussed above. That is, in the case where the sports mode is selected by the driver as the shift mode, it is considered that shifting from the second speed to the first speed is started with the brake B1 slipping at the time when it is determined in step S170 of FIG. 7 that the input rotational speed Nin is higher than the second reference rotational speed Nin2 (at time t10 in FIG. 9), and disengagement control for the brake B1 in which the hydraulic pressure command value Psl4* is reduced as indicated by the solid line in FIG. 9 is started. In the time chart illustrated in FIG. 9, it is assumed that the vehicle speed V is raised at a constant acceleration as the time elapses.

In this way, in the case where the sports mode is selected, by judging that the brake B1 should be disengaged and starting disengagement control for the brake B1 when the input rotational speed Nin is higher than the second reference rotational speed Nin2, it is possible to favorably suppress a continuous slip of the brake B1 after shifting from the second speed as the starting speed to the first speed as the lower speed is started, promptly complete shifting from the second speed to the first speed, and favorably meet the drive force request from the driver in the sports mode for improving the response of torque output to the output shaft 27. Then, in the case where the sports mode is selected, it is unlikely that the driver feels uncomfortable with a shock due to fluctuations in output torque Tout of the automatic transmission 25 that accompany disengagement of the brake B1 and engagement of the one-way clutch F1.

In the case where the comfort mode is selected by the driver as the shift mode, meanwhile, it is judged that the brake B1 should be disengaged when it is determined in step S200 of FIG. 7 that the input rotational speed Nin is equal to or more than the first reference rotational speed Nin1 (at time t3 in FIG. 9). That is, it can be judged that shifting from the second speed to the first speed has been substantially completed if the input rotational speed Nin is equal to or more than the first reference rotational speed Nin1 which is determined by the speed ratio γ1 at the first speed and the vehicle speed V. Thus, by starting disengagement control for the brake B1 in which the hydraulic pressure command value Psl4* is reduced as indicated by the fine broken line in FIG. 9 when the input rotational speed Nin is equal to or more than the first reference rotational speed Nin1 with the comfort mode selected, it is possible to favorably suppress occurrence of a shock due to fluctuations in output torque Tout of the automatic transmission 25 that accompany disengagement of the brake B1 and engagement of the one-way clutch F1. Also by starting disengagement control for the brake B1 when the input rotational speed Nin is equal to or more than the first reference rotational speed Nin1, it is possible to promptly complete shifting from the second speed as the starting speed to the first speed as the lower speed compared to a case where it is determined whether or not to change the shift speed from the second speed to the first speed using the speed change map or the like and disengagement control for the brake B1 is started in accordance with the determination result.

In the case where the normal mode is selected by the driver as the shift mode, further, it is judged that the brake B1 should be disengaged when it is determined in step S210 of FIG. 7 that the value obtained by subtracting the input rotational speed Nin from the first reference rotational speed Nin1 is equal to or less than the predetermined value a (at time t2 in FIG. 9), and disengagement control for the brake B1 in which the hydraulic pressure command value Psl4* is reduced as indicated by the rough broken line in FIG. 9 is started. Consequently, in the case where the normal mode is selected, it is possible to promptly complete shifting from the second speed as the starting speed to the first speed as the lower speed while suppressing occurrence of a shock that accompanies disengagement of the brake B1 and engagement of the one-way clutch F1.

As has been described above, the speed change ECU 21 as the control device for the automatic transmission 25 engages the clutch C1 (first engagement element) and the brake B1 (second engagement element) such that the automatic transmission 25 establishes the second speed as the starting speed when starting the automobile 10, and maintains the clutch C1 in the engaged state when the speed change condition for changing the shift speed of the automatic transmission 25 from the second speed to the first speed as the lower speed is met (step S180). Then, with the second speed established, the speed change ECU 21 engages the brake B1 so as to slip when the speed change condition for shifting from the second speed to the first speed is met (steps S100 and S110). That is, with the second speed established, the speed change ECU 21 controls the hydraulic control device 50 so as to supply the clutch C1 with a hydraulic pressure that maintains the clutch C1 in an engaged state that matches the target torque capacity Tc1 (the product of the engine torque Te, the torque distribution ratio for the clutch C1, and the safety factor). In addition, with the second speed established, the speed change ECU 21 controls the hydraulic control device 50 so as to supply the brake B1 with a hydraulic pressure that maintains the brake B1 in an engaged state that matches the target torque capacity Tb1 (the product of the second speed maximum torque Temax2 corresponding to the current vehicle speed V, the torque distribution ratio for the brake B1, and the safety factor (a value of 1.0)) and cause the brake B1 to slip as torque for shifting from the second speed to the first speed (torque that is larger than the second speed maximum torque Temax2 corresponding to the current vehicle speed V) is input to the input shaft 26. In this way, by causing the brake B1 to slip as torque for shifting from the second speed to the first speed is input to the input shaft 26 with the second speed as the starting speed established, shifting from the second speed to the first speed is started automatically, that is, without judging whether or not the speed change condition is met, when the speed change condition for shifting from the second speed to the first speed is met in response to the drive force request from the driver, and the one-way clutch F1 is engaged to establish the first speed. Consequently, it is possible to promptly change the shift speed of the automatic transmission 25 from the second speed to the first speed in response to the drive force request from the driver after the automobile 10 is started.

In addition, the speed change ECU 21 determines on the basis of the input rotational speed Nin of the automatic transmission 25 whether or not the brake B1 should be disengaged (steps S170, S200, and S210), and starts disengagement control for the brake B1 (step S180) after it is determined that the brake B1 should be disengaged by detecting start of shifting to the first speed (variations in rotation from the rotational speed at the second speed) on the basis of the input rotational speed Nin. In this way, by starting disengagement control for the brake B1 after start of shifting to the first speed is detected on the basis of the input rotational speed Nin, it is possible to suppress a continuous slip of the brake B1 after shifting from the second speed to the first speed is started, and to promptly complete shifting from the second speed to the first speed.

Further, in the case where the sports mode is selected by the driver as the shift mode, the speed change ECU 21 determines that the brake B1 should be disengaged when the input rotational speed Nin is higher than the second reference rotational speed Nin2 which is determined by the speed ratio γ2 at the second speed and the vehicle speed V (or the output rotational speed Nout) (step S170). That is, it can be judged that shifting from the second speed to the first speed has been started with the brake B1 slipping if the input rotational speed Nin is higher than the second reference rotational speed Nin2 which is determined by the speed ratio γ2 at the second speed and the vehicle speed V. Thus, if disengagement control for the brake B1 is started after the input rotational speed Nin is higher than the second reference rotational speed Nin2 (step S180), it is possible to favorably suppress a continuous slip of the brake B1 after shifting from the second speed to the first speed is started, and to promptly complete shifting from the second speed to the first speed to favorably meet the drive force request from the driver in the sports mode.

In addition, in the case where the comfort mode is selected by the driver as the shift mode, the speed change ECU 21 determines that the brake B1 should be disengaged when the input rotational speed Nin is equal to or more than the first reference rotational speed Nin1 which is determined by the speed ratio γ1 at the first speed and the vehicle speed V (or the output rotational speed Nout) (step S210). That is, it can be judged that shifting from the second speed to the first speed has been substantially completed with the brake B1 slipping if the input rotational speed Nin is equal to or more than (has reached) the first reference rotational speed Nin1 which is determined by the speed ratio γ1 at the first speed and the vehicle speed V. Thus, if disengagement control for the brake B1 is started after the input rotational speed Nin reaches the first reference rotational speed Nin1 with the comfort mode selected, it is possible to complete shifting from the second speed to the first speed while favorably suppressing occurrence of a shock that accompanies disengagement of the brake B1 and engagement of the one-way clutch F1.

Further, in the case where the normal mode is selected by the driver as the shift mode, the speed change ECU 21 determines that the brake B1 should be disengaged when the value obtained by subtracting the input rotational speed Nin from the first reference rotational speed Nin1 is equal to or less than the predetermined value a (step 200), and thereafter starts disengagement control for the brake B1. Consequently, in the case where the normal mode is selected, it is possible to promptly complete shifting from the second speed to the first speed while suppressing occurrence of a shock that accompanies disengagement of the brake B1 and engagement of the one-way clutch F1.

In addition, when the target torque capacities Tc1 and Tb1 for the clutch C1 and the brake B1, respectively, are set during execution of the starting control routine, the speed change ECU 21 sets the target torque capacity Tb1 using a safety factor that is smaller than the safety factor used to set the target torque capacity Tc1. In this way, by making the safety factor used to set the target torque capacity Tb1 smaller than the safety factor used to set the target torque capacity Tc1, it is possible to easily set the target torque capacity Tb1 such that the brake B1 slips as the speed change condition is met with the second speed engaged.

In the embodiment, further, with the second speed as the starting speed established, engagement of the brake B1 is maintained if torque output from the engine 12 is equal to or less than the second speed maximum torque Temax2 (maximum output torque at the starting speed) which is based on torque that matches the accelerator operation amount Acc and the vehicle speed V on the 2-1 downshift line for determining shifting from the second speed to the first speed, and the brake B1 slips if torque output from the engine 12 exceeds the second speed maximum torque Temax2. Consequently, it is possible to adequately change the shift speed from the second speed as the starting speed to the first speed as the lower speed in response to the drive force request from the driver.

In addition, the second speed maximum torque Temax2 (maximum output torque at the starting speed) is determined to be less than the output torque of the engine 12 at the time when the accelerator operation amount Acc is maximum (100%) with the second speed established in the case where the vehicle speed V is less than the predetermined vehicle speed Vref, and determined to be the output torque of the engine 12 at the time when the accelerator operation amount Acc is maximum (100%) with the second speed established in the case where the vehicle speed V is equal to or more than the predetermined vehicle speed Vref.

The automatic transmission 25 discussed above establishes the second speed (starting speed) through engagement of only the clutch C1 (first engagement element) and the brake B2 (second engagement element), and establishes the first speed (lower speed) through engagement of only the clutch C1 (first engagement element) and the one-way clutch F1. However, application of the present invention is not limited to such a transmission. That is, the present invention may also be applied to a transmission that establishes a starting speed through engagement of a plurality of clutches and brakes (first engagement elements) and a second engagement element, and that establishes a lower speed through engagement of a plurality of clutches etc. (first engagement elements) and a one-way clutch.

The correspondence between the main elements of the embodiment described above and the main elements of the exemplary embodiment described in the “SUMMARY” section does not limit the elements of the invention described in the “SUMMARY” section, because the embodiment described above is an example given for the purpose of specifically describing the exemplary embodiment described in the “SUMMARY” section. That is, the embodiment is merely a specific example of the described in the “SUMMARY” section, and the exemplary embodiment described in the “SUMMARY” section should be construed on the basis of the description in that section.

While an embodiment of the present exemplary embodiment has been described above, it is a matter of course that the present invention is not limited to the embodiment described above in any way, and that the present invention may be modified in various ways without departing from the scope and sprit of the present invention.

### INDUSTRIAL APPLICABILITY

The present invention can be utilized in the transmission manufacturing industry etc.

1. A control device for a transmission capable of transferring power transferred from a motor mounted on a vehicle to an input shaft to an output shaft with a speed of the power changed at a speed ratio of a plurality of shift speeds established through engagement and disengagement of a plurality of engagement elements, the transmission being configured to establish a starting speed through engagement of first and second engagement elements to which a hydraulic pressure is supplied from a hydraulic control device, and to establish a lower speed having a speed ratio that is higher than that of the starting speed through engagement of the first engagement element and a one-way clutch, the control device comprising:
starting controller configured to engage the first and second engagement elements such that the transmission establishes the starting speed by controlling the hydraulic control device when the vehicle is started, wherein
the starting controller controls the hydraulic control device, with the starting speed established, so as to supply the first engagement element with a hydraulic pressure to maintain an engaged state and supply the second engagement element with a hydraulic pressure to maintain an engaged state and causing the second engagement element to slip as torque for shifting from the starting speed to the lower speed is input to the input shaft.

2. The control device for a transmission according to claim 1, further comprising:
disengagement configured to start disengagement control for the second engagement element after detecting start of shifting to the lower speed on the basis of a rotational speed of the input shaft.

3. The control device for a transmission according to claim 2, wherein
the disengagement controller starts the disengagement control for the second engagement element after the rotational speed of the input shaft becomes higher than a reference rotational speed determined by the speed ratio at the starting speed and a vehicle speed or a rotational speed of the output shaft.

4. The control device for a transmission according to claim 2, wherein
the disengagement controller starts the disengagement control for the second engagement element after the rotational speed of the input shaft reaches a reference rotational speed determined by the speed ratio at the lower speed and a vehicle speed or a rotational speed of the output shaft.

5. The control device for a transmission according to claim 2, wherein
the disengagement controller starts the disengagement control for the second engagement element after a value obtained by subtracting the rotational speed of the input shaft from a reference rotational speed determined by the speed ratio at the lower speed and a vehicle speed or a rotational speed of the output shaft becomes equal to or less than a predetermined value.

6. The control device for a transmission according to claim 1, further comprising:
target torque capacity setting device configured to set a first target torque capacity for the first engagement element and a second target torque capacity for the second engagement element with the starting speed established, wherein
the target torque capacity setting means sets the second target torque capacity using a safety factor that is smaller than a safety factor used to set the first target torque capacity.

7. The control device for a transmission according to claim 1, wherein
with the starting speed established, the second engagement element is kept engaged if torque output from the motor is equal to or less than maximum output torque at the starting speed which is based on torque that matches an accelerator operation amount and a vehicle speed on a downshift line for determining shifting from the starting speed to the lower speed, and the second engagement element slips if the torque output from the motor exceeds the maximum output torque at the starting speed.

8. The control device for a transmission according to claim 7, wherein
the maximum output torque at the starting speed is determined as torque that is smaller than output torque of the motor at the time when the accelerator operation amount is maximum with the starting speed established in the case where the vehicle speed is less than a predetermined vehicle speed, and determined as the output torque in the case where the vehicle speed is equal to or more than the predetermined vehicle speed.

9. A control method for a transmission capable of transferring power transferred from a motor mounted on a vehicle to an input shaft to an output shaft with a speed of the power changed at a speed ratio of a plurality of shift speeds established through engagement and disengagement of a plurality of engagement elements, the transmission being configured to establish a starting speed through engagement of first and second engagement elements to which a hydraulic pressure is supplied from a hydraulic control device, and to establish a lower speed having a speed ratio that is higher than that of the starting speed through engagement of the first engagement element and a one-way clutch, the control method comprising:
(a) a step of engaging the first and second engagement elements such that the transmission establishes the starting speed by controlling the hydraulic control device when the vehicle is started, wherein
the step (a) includes controlling the hydraulic control device, with the starting speed established, so as to supply the first engagement element with a hydraulic pressure for maintaining an engaged state and supply the second engagement element with a hydraulic pressure for maintaining an engaged state and causing the second engagement element to slip as torque for shifting from the starting speed to the lower speed is input to the input shaft.
